(19) United States
(12) Patent Application Publication
(10) Pub. No.: US 2023/0359980 A1
(43) Pub. Date: Nov. 9, 2023

(54) RECURSIVE MULTI-CRITERIA PHYSICAL INTERNET (PI) FREIGHT ORCHESTRATION

(71) Applicant: Inlecom Group BV, Bruxelles (BE)

(72) Inventors: Konstantinos ZAVITSAS, London (GB); Aristides HALATSIS, Thessaloniki (GR); Gerasimos KOULOUMBIS, Ntrafi-Pikermi (GR); Panayotis KATSOULAKOS, Haywards Heath (GB); Patrick J. O'Sullivan, Dublin (IE)

(73) Assignee: Inlecom Group BV, Bruxelles (BE)

(21) Appl. No.: 17/735,379

(22) Filed: May 3, 2022

(51) Int. Cl. G06Q 10/08

(52) U.S. Cl. CPC G06Q 10/08355

(57) ABSTRACT

Recursive multi-criteria Physical Internet (PI) freight orchestration includes the loading a hierarchy of connected nodes and specifying a starting node and ending node within the hierarchy. Different combinations of the connected nodes are determined which connect the starting node and the ending node, each defining a corresponding routing of the freight in a set of possible routings. Thereafter, for each corresponding routing of the freight, a route value is recursively computed from the starting node through the ending node and across different intermediate nodes of the routing for the freight connecting the starting node and the ending node. Each recursively computed route value is processed in order to select, amongst the possible routings, a selected routing for transporting the freight to the geographic destination and a record can be written with the selected routing for transporting the freight to the geographic destination.

### BACKGROUND OF THE INVENTION

### Field of the Invention

The present invention relates to the technical field of supply chain logistics and more particularly to the automated route selection for freight during freight orchestration.

### Description of the Related Art

A supply chain is a network between a company and its suppliers to produce and distribute a specific product, and the supply chain represents the steps it takes to get the product or service to the customer. Supply chain management is a crucial process because an optimized supply chain results in lower costs and a faster production cycle. Business logistics management refers to the production and distribution process within the company, while supply chain management includes suppliers, manufacturers, logistics and transportation companies and retailers that distribute the product to the end customer. Supply chains include every organization with which a particular product of the business comes into contact, including organizations that assemble and deliver parts to the manufacturer and organizations that transport both the component parts and finished products from the source to the ultimate customer.

Part and parcel of the integrated supply chain is the effective routing of a shipping container, from an origin to a destination. The freight forwarder generally acts as the organization charged with the orchestration of movement of freight. Typically, the freight forwarder selects a route for transporting a shipping freight according to the shortest geographic path to the destination in order to cause the delivery of the shipping container by a requested delivery date. The decision making by the freight forwarder is subject to only a few constraining criteria, paramount among which are the pre-established relationships between the freight forwarder and different road, rail, air and sea transporters, and of course, the limitation of cost. Obviously, longer paths or longer times in transit are tolerated in exchange for a cheaper cost of transport. However, it has been observed that the freight forwarder prefers to limit the number of modes of transport utilized in shipment so as to avoid a more complex oversight burden.

In supply chain logistics, the Physical Internet or “PI” is an open global logistics system founded on physical, digital, and operational interconnectivity, through encapsulation, interfaces and protocols. More than a decade ago, Professor Benoit Montreuil, a professor in the department of operations and decision systems at the Universite Laval in Quebec and a member of the College-Industry Council on Material Handling Education (CICMHE) conceived of PI as an improvement to distribution and logistics by applying some of the principles of the digital Internet to the physical movement of goods. To that end, the Physical Internet centers around the basic notion that a shipping container, as a package encapsulator, behaves like packets of the well-known Internet Protocol (IP) of the digital Internet, and moves from an origin to a destination along a route according to transport directives akin to the transport control protocol (TCP) of the digital Internet.

Given the preference by the freight forwarder to limit modes of transport in order to minimize the management burden of the transport of freight upon the freight forwarder, notions of PI remain absent in the decision making of the freight forwarder. As such, routing of freight is determined by the freight forwarder statically prior to the initial movement of the freight from its origin and the routing decision making is limited to simplistic criteria such as basic cost of transport, specific container criteria such as temperature control and size, the required security for shipment of the freight, a required delivery date and the knowledge of potential transporters in an existing relationship with the freight forwarder. Absent from the routing determination are more complex constraining criteria such as emissions goals, safety and past performance. As well, in so far as these complex constraints and the simplistic constraints are valued differently by different customers, it can be challenging to formulate a selection process satisfactory to each of the different customers.

### BRIEF SUMMARY OF THE INVENTION

Embodiments of the present invention address technical deficiencies of the art in respect to multi-criteria freight orchestration. To that end, embodiments of the present invention provide for a novel and non-obvious method for recursive multi-criteria PI freight orchestration. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, recursive multi-criteria PI freight orchestration includes the loading into memory of a host computing platform, a hierarchy of connected nodes. Both a starting node and also an ending node are then specified within the hierarchy so that the starting node defines a geographic origin of shipment of freight while the ending node defines a geographic destination of the freight. A processor of the host computing platform then determines different combinations of the connected nodes connecting the starting node and the ending node, with each of the different combinations defining a corresponding routing of the freight in a set of possible routings. Thereafter, for each corresponding routing of the freight, a route value is recursively computed from the starting node through the ending node and across different intermediate nodes of the routing for the freight connecting the starting node and the ending node.

In this regard, the recursive computation of the route value requires the computation of a numeric value based upon a weighted combination of scores for different criterion evaluated based upon a transport of the freight to a target node nearer to the ending node from a source node nearer to the starting node. The criterion include at least a cost of the transport of the freight, a date of delivery of the freight at the geographic destination and fossil fuel emissions resulting from the transport of the freight. As the computation is recursive, the evaluation is first invoked at the starting node but is only initially performed beginning at the ending node. Thereafter the computation is performed in an unwinding fashion in each prior one of the intermediate nodes with each computed numeric value for each evaluation combining into a combined numeric value. The computation and combination continues until the evaluation is performed at the starting node resulting in the combined numeric value for the corresponding routing of the freight.

Once the recursive computation of route value has been performed for each routing in the set of possible routings, each recursively computed route value is processed in order to select, amongst the possible routings, a selected routing for transporting the freight to the geographic destination. In this regard, the processing can be as simple as selecting a highest one of the computed route values, or a lowest one of the computed route values. With more complexity, the processing can exclude ones of the routings having a cost criterion that exceeds a pre-determined threshold value. In so far as each one of the criterion is weighted, the criterion of emissions can be weighted to have greater importance than the other criterion. Once one of the possible routings has been selected, a record can be written to fixed storage of the host computing platform with the selected routing for transporting the freight to the geographic destination.

In accordance with the PI and unlike the static conventional methodology for selecting routing, in accordance with an aspect of the embodiment, the recursive computation of route values for prospective routings can be performed at each node along a selected routing as the freight is in transport from the geographic origin to the geographic destination. To that end, the method additionally includes specifying a first one of the connected nodes directly connected to the starting node in the selected routing as a new starting node and determining different combinations of the connected nodes connecting the new starting node and the ending node, with the result that each of the different combinations defines a corresponding routing for the freight in a new set of possible routings. Then, the recursive computation is repeated for each one of the different combinations in the new set of possible routings and each repeated recursive computation of the route value is processed in order to select, amongst the new set of possible routings, a new selected routing for transporting the freight to the geographic destination. Further, the foregoing steps may be repeated for additional connected nodes directly connected to the new starting node until the new starting node is the ending node.

In another embodiment of the invention, a data processing system is adapted for recursive multi-criteria PI freight orchestration. The system includes a host computing platform which includes one or more computers, each with memory and one or processing units including one or more processing cores and fixed storage. The system also includes a recursive multi-criteria PI freight orchestration module. The module has computer program instructions enabled while executing in the memory of at least one of the processing units of the host computing platform to load into the memory of the host computing platform, a hierarchy of connected nodes and to specify in the hierarchy, the starting node and the ending node. The program instructions further determine by one of the processing units of the host computing platform, different combinations of the connected nodes connecting the starting node and the ending node, with each of the different combinations defining a corresponding routing of the freight in a set of possible routings.

Thereafter, the program instructions, for each corresponding routing of the freight, recursively compute a route value from the starting node through the ending node and across different intermediate nodes of the routing for the freight connecting the starting node and the ending node. Subsequently, the program instructions process each recursively computed route value in order to select, amongst the possible routings, a selected routing for transporting the freight to the geographic destination. Finally, the program instructions write a record in the fixed storage of the host computing platform with the selected routing for transporting the freight to the geographic destination.

In this way, the technical deficiencies of the static freight forwarder routing based upon limited constraining criteria are overcome owing to the consideration of multiple criterion including emissions, with different criterion enjoying different specifiable weights consistent with the values of the customer, and also the continuous re-evaluation of routing choice at each node along the path to the ending destination for the freight.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of recursive multi-criteria PI freight orchestration;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for recursive multi-criteria PI freight orchestration. In accordance with an embodiment of the invention, a set of possible routings may be computed between a geographic origin and geographic destination of freight based upon a data model of freight transport nodes within a geographic region. Then, for each routing a route value is computed, recursively from the start node to the end node with numeric values produced beginning at the end node and unwinding to the start node. The numeric values compute according to different criterion which include at least cost, date of delivery and emissions. Additionally, the numeric values are weighted to prioritize some of the values over others. The values are then combined to produce a route value for each of the possible routings and a specific one of the routings is selected for the transport of the freight based upon the preferred route value. As the freight traverses the selected routing, the process repeats substituting a contemporaneous node for the start node. In this way, the desirability of a particular routing can be determined recursively at each node along the transport path from geographic origin to geographic destination with multiple criterion considered by weighted differently according to value.

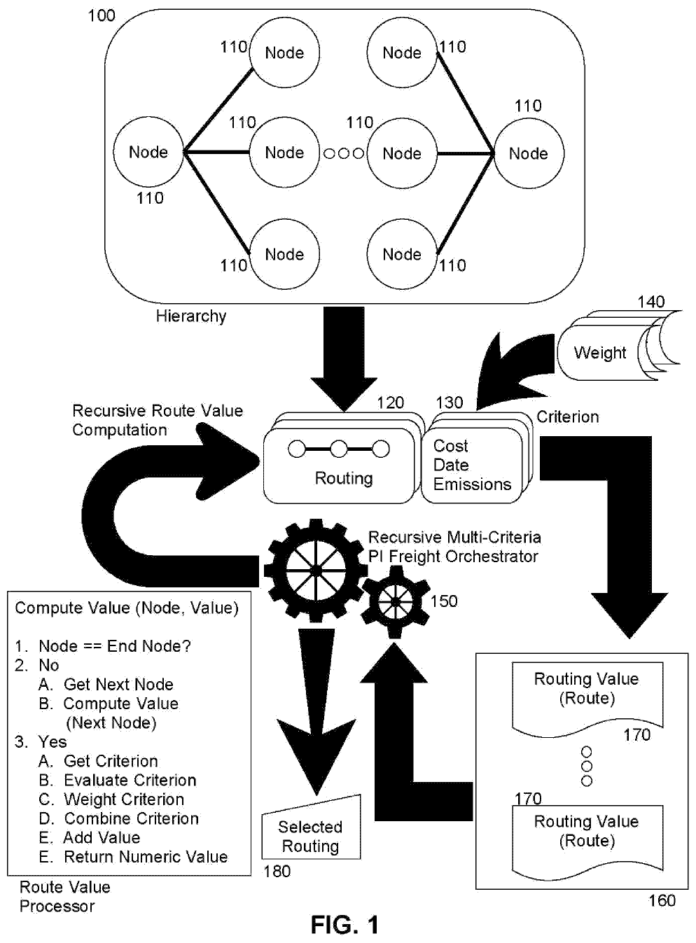

In illustration of one aspect of the embodiment, FIG. 1 pictorially shows a process of recursive multi-criteria PI freight orchestration. As shown in FIG. 1, a hierarchy 100 of nodes 110 in memory of a host computing platform models a logistics supply chain within a geographic region. Each of the nodes 110 represents a transporter of freight within a prospective path from an origin one of the nodes 110 to a destination one of the nodes 110. As such, upon defining a starting one of the nodes 110 and an ending one of the nodes 110, a set of multiple different prospective routings 120 can be generated each incorporating a unique sequence of the nodes 110 leading from the starting one of the nodes 110 to the ending one of the nodes 110.

A selection of criterion 130 can be defined in the evaluation of a routing between the starting one of the nodes 110 and the ending one of the nodes 110. The criterion 130 as different key performance indicators (KPIs) can include, but are not limited to, the cost of transport of freight from one of the nodes 110 to another, a delivery date when freight must arrive at one of the nodes 110, and emissions emitted during the transport of the freight between nodes 110. Other criterion 130 may include time of travel, a rating of service quality of a selected transporter, past observed punctuality of the selected transporter and a rating of reliability of the selected transporter.

Notably, an additional one of the criterion 130 can include an ability to consolidate the freight with a transporter with other freight so as to reduce the number of transports necessary to transport freight. This additional criterion 130 can be reduced to a value corresponding to asset utilization with a higher value indicative of greater availability to consolidate the freight with other freight along the prospective routing and a lower value indicative of a lesser availability to consolidate the freight with other freight along the prospective routing. The availability can be measured in terms of the excess volumetric area present in different transporting vehicles at a particular node compared to the required volumetric area for the freight with any value less than unity indicating no availability at all.

Each of the criterion 130 can be reduced to a numeric value. Importantly, different weights 140 can be applied to individual ones of the criterion 130 in order to express a relative importance of each of the criterion 130 relative to others of the criterion 130. In this regard, emissions as one of the criterion 130 can be assigned a highest value in a corresponding one of the weights 140. As such, the numeric value for each of the criterion 130 at one of the nodes 110 can be combined, subsequent to the application of the weights 140, to produce a route value 170 for transporting freight from one of the nodes 110 to another, whether the route value 170 reflects the transport of the freight between two adjacent ones of the nodes 110, or across several ones of the nodes 110, or from the starting one of the nodes 110 to the ending one of the nodes 110.

To that end, a recursive multi-criteria PI freight orchestrator 150 recursively directs the computation of a route value 170 for each one of the routings 120 in the set. In particular, as the route value process is invoked for one of the nodes 110 in a corresponding one of the routings 120, it is determined if additional ones of the nodes 110 remain in the path to the ending one of the nodes 110 in the corresponding one of the routings 120. If so, the very same route value process is invoked for a next adjacent one of the nodes 110 in the path and processing within the route value process for the one of the nodes 110 pending the completion of the route value process in the next adjacent one of the nodes 110. This process continues, recursively, until reaching the ending one of the nodes 110 at which point the first component of the route value 170 is determined with respect to the ending one of the nodes 110 and then the recursive invocation of the route value process unwinds backwards along the path towards the starting one of the nodes 110. At each of the nodes, the route value process maintains a running sum of all nodal components of the route value 170 returned by the route value process for the upstream ones of the nodes 110 so that upon reaching the one of the nodes 110 at which the recursive multi-criteria PI freight orchestrator 150 had first invoked the route value process in order to produce the route value 170 for the corresponding one of the routings 120.

Once the recursive multi-criteria PI freight orchestrator 150 has computed a set 160 of the route values 170 for the prospective routings 120, the recursive multi-criteria PI freight orchestrator 150 processes the route values 170 formulaically in order to generate a selected routing 180 from amongst routings 120 in the set. By formulaically, it is meant that the one of the routings 120 with a highest one of the route values 170 can be selected, or the one of the routings 120 with a lowest one of the route values 170 can be selected. In a more complex arrangement, ones of the route values 120 in which the total cost component exceeds a threshold value can be excluded from selection leaving a subset of the routines 120 from which the selected routing 180 can be determined.

Upon selecting the selected routing 180, the recursive multi-criteria PI freight orchestrator 150 writes a record to fixed storage directing the physical movement of the freight to the next one of the nodes 110 in the path of the selected routing 180. Then, in that some time will have then elapsed permitting changes in the route values 170, the multi-criteria PI freight orchestrator 150 directs a repeating of the process in which a new set of routings 120 are determined with the next one of the nodes 110 acting as the starting one of the nodes 110 and the ending one of the nodes 110 remaining the same. In this way, the path of the freight from the geographic origin to the geographic destination can adapt, dynamically according to changing conditions resulting in the computation of different route values 170 adjusted according to the weights 140 reflecting the subjective prioritization of the criterion 130.

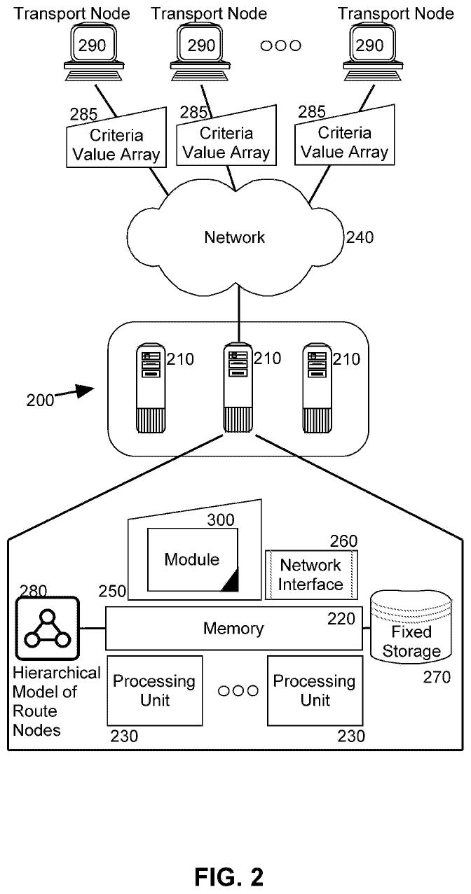

Aspects of the process described in connection with FIG. 1 can be implemented within a data processing system. In further illustration, FIG. 2 schematically shows a data processing system adapted to perform recursive multi-criteria PI freight orchestration. In the data processing system illustrated in FIG. 2, a host computing platform 200 is provided. The host computing platform 200 includes one or more computers 210, each with memory 220 and one or more processing units 230 and fixed storage 270. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for recursive multi-criteria PI freight orchestration. Specifically, the program instructions during execution generate a hierarchical model 280 of a logistics supply chain for a geographic region with different nodes of the hierarchical model 280 reflecting different intermediate transport hubs at which the mode of transport changes from one transporter to another with a first one of the nodes reflecting a geographic origin of freight and a second one of the nodes reflecting a geographic destination of the freight and other nodes in the hierarchical model 280 in a connected path between the first and second one of the nodes reflecting a prospective routing of the freight from the geographic origin to the geographic destination.

To that end, the program instructions during execution generate a listing of possible routings in the memory 220 for freight slated for transport from a geographic origin to a geographic destination, corresponding to a starting node in the hierarchical model 280, and an ending node in the hierarchical model 280. Then, for each routing in the listing, the program instructions direct the recursive computation of a route value according to criterion specified in the memory 220. More particularly, from each of the transport hubs 290 corresponding to a node in the hierarchical model 280 and included in a subject one of the routings, an array of numeric values 285 can be received from over the data communications network 240 for use in evaluating the route value for the subject one of the routings. Examples include observed emissions in transporting freight in the past, frequency of timeliness in delivering freight by a specific delivery date, and specified costs of transport. Finally, each component of the route value is weighted according to weights determined for each of the criterion reflective of the relative importance of a corresponding one of the criterion.

The program instructions then process the route values for each of the routings in the listing in order to select a preferred one of the routings. Thereafter, the program instructions write a record to fixed storage 270 directing transport of the freight to the one of the transport hubs 290 corresponding to the next node in the selected one of the routings. Upon confirming arrival of the freight at the one of the transport hubs 290, the program instructions repeat the process by again, determining listing of all possible routings to the ending node in the hierarchical model 280 and directing the recursive computation of a route value for each of the routings in the listing according to the weighted criterion in the memory 220. The program instructions continue this process until it is determined that the next node in the selected one of the routings is the ending node thus indicating that the freight will have completed the path to the geographic destination.

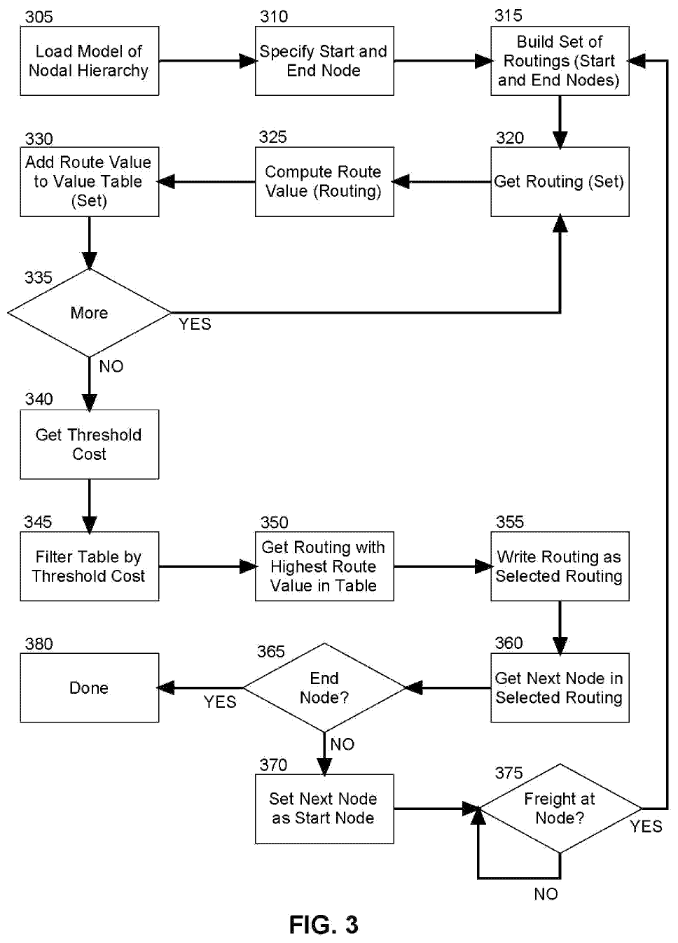

In further illustration of an exemplary operation of the module, FIG. 3 is a flow chart illustrating one of the aspects of the process of FIG. 1. Beginning in block 305, a hierarchical model of a logistics supply chain of different interconnected transport hubs is loaded into memory and in block 310, both a starting node and an ending node are specified. In block 315, a set of different possible routings between the starting node and the ending node are constructed as a sequence of the nodes in the hierarchical model. Thereafter, in block 320, a first one of the routings is selected for route valuation.

Specifically, in block 325 the route value for the first one of the routings is computed in a recursive manner with the directive to initiate the valuation beginning in reference to the starting node and the computation of the components of the valuation beginning in reference to the ending node and then unwinding to the starting node, with each intermediate determining of the computation of the components accumulating as a single sum, the final sum producing the route value for the first one of the routings. The route value is an amalgamation of different values corresponding to different KPIs selected for the hierarchical model. Each of the KPIs can be afforded a different weight corresponding to a perceived importance of a weighted one of the KPIs relative to others of the KPIs.

In block 330, the route value is added to a table of route values in connection with the first one of the routings. Then, in decision block 335 it is determined if additional routings remain to be considered in the set of different possible routings. If so, the process returns to block 320 with a new one of the routings selected for consideration and in block 330 with a new route value being computed for the new one of the routings. In decision block 335, when a route value has been computed and stored in the table in respect to each of the routings in the set, in block 340, a threshold cost is retrieved beyond which a routing is determined to be disfavored for selection. Then, in block 3245, the routings referenced in the table are filtered to excluded therefrom any one of the routings with a cost component which exceeds the threshold cost. Subsequently, amongst the remaining routings, a routing with a highest route value is selected as the preferred routing and in block 355, a record is written to fixed storage directing the utilization of the preferred routing.

Once the preferred routing has been selected, a next node in the preferred routing is identified in the hierarchical model in block 360. In decision block 365, it is determined if the identified node is the ending node in the routing for the freight. If not, in decision block 370 the next node is set as the start node. Then, in decision block 375 it is determined whether or not the freight has physically arrived at the transport hub corresponding to the next node—for instance through the receipt of a message from a computing client at the transport hub, or through a change in a record stored in fixed storage indicating a real time location of the freight. Once it is determined that the freight has arrived at the transport hub, the process returns to block 315, this time with the next node as the start node so that a new preferred routing is determined from amongst a newly generated set of possible routings in block 315. When it is determined in block 365 that the next node is the ending node, the process ends in block 380.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for recursive multi-criteria Physical Internet (PI) freight orchestration comprising:
loading into memory of a host computing platform, a hierarchy of connected nodes;
specifying in the hierarchy, a starting node and an ending node, the starting node defining a geographic origin of shipment of freight and the ending node defining a geographic destination of the freight;
determining by a processor of the host computing platform, different combinations of the connected nodes connecting the starting node and the ending node, each of the different combinations defining a corresponding routing of the freight in a set of possible routings;
for each said corresponding routing of the freight, recursively computing a route value from the starting node through the ending node and across different intermediate nodes of the routing for the freight connecting the starting node and the ending node, the recursive computation of the route value computing a numeric value based upon a weighted combination of scores for different criterion evaluated based upon a transport of the freight to a target node nearer to the ending node from a source node nearer to the starting node, the criterion including at least a cost of the transport of the freight, a date of delivery of the freight at the geographic destination and fossil fuel emissions resulting from the transport of the freight, the evaluation being invoked at the starting node but being initially performed only beginning at the ending node and thereafter being performed in an unwinding fashion in each prior one of the intermediate nodes with each computed numeric value for each evaluation combining into a combined numeric value, until the evaluation is performed at the starting node to produce the combined numeric value for said corresponding routing of the freight;
processing each recursively computed route value in order to select, amongst the possible routings, a selected routing for transporting the freight to the geographic destination; and,
writing a record in fixed storage of the host computing platform with the selected routing for transporting the freight to the geographic destination.

2. The method of claim 1, further comprising:
specifying a first one of the connected nodes directly connected to the starting node in the selected routing as a new starting node;
determining different combinations of the connected nodes connecting the new starting node and the ending node, each of the different combinations defining a corresponding routing for the freight in a new set of possible routings;
repeating the recursive computation for each one of the different combinations in the new set of possible routings; and,
processing each repeated recursive computation of the route value in order to select, amongst the new set of possible routings, a new selected routing for transporting the freight to the geographic destination.

3. The method of claim 2, further comprising repeating the specifying, determining, repeating and processing for additional ones of the connected nodes directly connected to the new starting node until the new starting node is the ending node.

4. The method of claim 1, wherein the processing is one of a selection of a highest route value and a selection of a lowest route value.

5. The method of claim 1, wherein the processing is one of a selection of a highest route value excluding ones of the possible routings associated with a numeric value for cost which exceeds a threshold.

6. The method of claim 1, wherein ones of the scores computed for the criterion of emissions are weighted for greater importance than others of the criterion.

7. A data processing system adapted for recursive multi-criteria Physical Internet (PI) freight orchestration, the system comprising:
a host computing platform comprising one or more computers, each with memory and one or processing units including one or more processing cores and fixed storage; and,
a recursive multi-criteria PI freight orchestration module comprising computer program instructions enabled while executing in the memory of at least one of the processing units of the host computing platform to perform:
loading into the memory of the host computing platform, a hierarchy of connected nodes;
specifying in the hierarchy, a starting node and an ending node, the starting node defining a geographic origin of shipment of freight and the ending node defining a geographic destination of the freight;
determining by one of the processing units of the host computing platform, different combinations of the connected nodes connecting the starting node and the ending node, each of the different combinations defining a corresponding routing of the freight in a set of possible routings;
for each said corresponding routing of the freight, recursively computing a route value from the starting node through the ending node and across different intermediate nodes of the routing for the freight connecting the starting node and the ending node, the recursive computation of the route value computing a numeric value based upon a weighted combination of scores for different criterion evaluated based upon a transport of the freight to a target node nearer to the ending node from a source node nearer to the starting node, the criterion including at least a cost of the transport of the freight, a date of delivery of the freight at the geographic destination and fossil fuel emissions resulting from the transport of the freight, the evaluation being invoked at the starting node but being initially performed only beginning at the ending node and thereafter being performed in an unwinding fashion in each prior one of the intermediate nodes with each computed numeric value for each evaluation combining into a combined numeric value, until the evaluation is performed at the starting node to produce the combined numeric value for said corresponding routing of the freight;
processing each recursively computed route value in order to select, amongst the possible routings, a selected routing for transporting the freight to the geographic destination; and,
writing a record in the fixed storage of the host computing platform with the selected routing for transporting the freight to the geographic destination.

8. The system of claim 7, wherein the program instructions are enabled to further perform:
specifying a first one of the connected nodes directly connected to the starting node in the selected routing as a new starting node;
determining different combinations of the connected nodes connecting the new starting node and the ending node, each of the different combinations defining a corresponding routing for the freight in a new set of possible routings;
repeating the recursive computation for each one of the different combinations in the new set of possible routings; and,
processing each repeated recursive computation of the route value in order to select, amongst the new set of possible routings, a new selected routing for transporting the freight to the geographic destination.

9. The system of claim 8, wherein the program instructions are enabled to further perform repeating the specifying, determining, repeating and processing for additional ones of the connected nodes directly connected to the new starting node until the new starting node is the ending node.

10. The system of claim 7, wherein the processing is one of a selection of a highest route value and a selection of a lowest route value.

11. The system of claim 7, wherein the processing is one of a selection of a highest route value excluding ones of the possible routings associated with a numeric value for cost which exceeds a threshold.

12. The system of claim 7, wherein ones of the scores computed for the criterion of emissions are weighted for greater importance than others of the criterion.

13. A computing device comprising a non-transitory computer readable storage medium having program instructions stored therein, the instructions being executable by at least one processing core of a processing unit to cause the processing unit to perform a method for recursive multi-criteria Physical Internet (PI) freight orchestration, the method including:
loading into memory of a host computing platform, a hierarchy of connected nodes;
specifying in the hierarchy, a starting node and an ending node, the starting node defining a geographic origin of shipment of freight and the ending node defining a geographic destination of the freight;
determining by a processor of the host computing platform, different combinations of the connected nodes connecting the starting node and the ending node, each of the different combinations defining a corresponding routing of the freight in a set of possible routings;
for each said corresponding routing of the freight, recursively computing a route value from the starting node through the ending node and across different intermediate nodes of the routing for the freight connecting the starting node and the ending node, the recursive computation of the route value computing a numeric value based upon a weighted combination of scores for different criterion evaluated based upon a transport of the freight to a target node nearer to the ending node from a source node nearer to the starting node, the criterion including at least a cost of the transport of the freight, a date of delivery of the freight at the geographic destination and fossil fuel emissions resulting from the transport of the freight, the evaluation being invoked at the starting node but being initially performed only beginning at the ending node and thereafter being performed in an unwinding fashion in each prior one of the intermediate nodes with each computed numeric value for each evaluation combining into a combined numeric value, until the evaluation is performed at the starting node to produce the combined numeric value for said corresponding routing of the freight;
processing each recursively computed route value in order to select, amongst the possible routings, a selected routing for transporting the freight to the geographic destination; and,
writing a record in fixed storage of the host computing platform with the selected routing for transporting the freight to the geographic destination.

14. The device of claim 13, wherein the method further includes:
specifying a first one of the connected nodes directly connected to the starting node in the selected routing as a new starting node;
determining different combinations of the connected nodes connecting the new starting node and the ending node, each of the different combinations defining a corresponding routing for the freight in a new set of possible routings;
repeating the recursive computation for each one of the different combinations in the new set of possible routings; and,
processing each repeated recursive computation of the route value in order to select, amongst the new set of possible routings, a new selected routing for transporting the freight to the geographic destination.

15. The device of claim 14, wherein the method further includes repeating the specifying, determining, repeating and processing for additional ones of the connected nodes directly connected to the new starting node until the new starting node is the ending node.

16. The device of claim 13, wherein the processing is one of a selection of a highest route value and a selection of a lowest route value.

17. The device of claim 13, wherein the processing is one of a selection of a highest route value excluding ones of the possible routings associated with a numeric value for cost which exceeds a threshold.

18. The device of claim 13, wherein ones of the scores computed for the criterion of emissions are weighted for greater importance than others of the criterion.
